(19) United States
(12) Patent Application Publication
(10) Pub. No.: US 2015/0343367 A1
(43) Pub. Date: Dec. 3, 2015

(54) CO2 modification

(71) Applicant: Edward Allen Zdunek, Crystal Lake, IL (US)

(72) Inventor: Edward Allen Zdunek, Crystal Lake, IL (US)

(21) Appl. No.: 14/287,790

(22) Filed: May 27, 2014

(51) Int. Cl. B01D 53/00; B01D 53/50; B01D 53/62

(52) U.S. Cl. CPC B01D 53/007; B01D 53/62; B01D 53/50; B01D 2258/0283; B01D 2259/80; B01D 2259/81

(57) ABSTRACT

In the stack there would be a matrix of high activity radioactive sources. These sources would create a large radiation field that the stack gases would have to pass through. As the gases pass through this radiation field the covalent bonds of the gases would be broken and the atoms would have to recombine to remain stable. They would create different percentages of gases after leaving the radiation field.

The innovation uses the technology of gamma irradiation of the CO2 gases in the plume of an exhaust stack from any major source of CO2.

High energy gammas or the coincidence effect of lower energy gammas have the ability to break the covalent bonds of molecules.

This currently occurs as a byproduct of gamma sterilization. During the irradiation of the product air is present within the sterilization facility. This air is also irradiated. The O2 component of the normal air has the covalent bond broke and the random recombination of the Oxygen atoms causes O2 and O3 to be formed.

In the unit designed for the exhaust stacks the gamma irradiation will break the bonds of the Co2 and SO2 molecules. By breaking these bonds there will be free carbon, sulfur, and oxygen atoms that will randomly recombine. As the plume gas is primarily nitrogen and CO2 the recombination will primarily occur with the carbon and oxygen atoms. The recombination of the carbon and Oxygen atoms will be random. This random recombination will produce CO, O2, O3 and CO2. The result is a smaller percentage of CO2 is exhausted from the stack. Effectively reducing the greenhouse gas emissions. This can be optimized by developing the correct dose rates and gamma energie to most effectively break down the CO2 molecules.

The gammas do not have the energy to activate molecules so there is no chance of creating any radioactive gases.

The next possible reduction in the gases would be to introduce a flame into the area where the highest percentage of breakdown is occurring. If the oxygen atoms can be used to assist the burning of the flame then a smaller number of oxygen atoms would be able to recombine.

1. This system will reduce the stack emissions of carbon dioxide.

2. This system will reduce the stack emissions of Sulfur dioxide.
